(19) United States
(12) Patent Application Publication
(10) Pub. No.: US 2006/0209918 A1
(43) Pub. Date: Sep. 21, 2006

(54) High power thin disk lasers

(76) Inventors: Zhijiang Wang, Diamond Bar, CA (US); Ying Wang, Diamond Bar, CA (US)

Correspondence Address: YING WANG, 23637 COUNTRY VIEW DR., DIAMOND BAR, CA, 91765, US

(21) Appl. No.: 11/376,792

(22) Filed: Mar. 15, 2006

Related U.S. Application Data
(60) Provisional application No. 60/662,922, filed on Mar. 16, 2005.

(51) Int. Cl. H01S 3/091; H01S 3/04; H01S 3/07; H01S 3/08

(52) U.S. Cl. 372/70; 372/67; 372/99; 372/34

(57) ABSTRACT

A device including an active mirror made of thin disk active medium having a pump surface and a mirror surface, means for cooling that contacts with the mirror surface of the active medium dissipating heat from said laser medium, pump beam illuminating the pump surface of said active mirror and a multi-reflection optical system wherein the pump beam is imaged numerous times with the beam structure substantially unchanged during imaging leading to sufficient absorption of the pump beam by said thin disk active medium.

### CROSS-REFERENCES TO RELATED APPLICATIONS

This continuation application claims the benefit of U.S. Provisional Patent Application No. 60/662,922, filed Mar. 16, 2005, entitled “High Power Thin Disk Lasers”.

### FIELD OF THE INVENTION

This invention relates to an active mirror (AM) allowing multiple passes of a beam by multiple imaging of the beam with substantially unchanged beam structure.

### BACKGROUND

In solid-state lasers, because of the deformation of active medium caused by the heat from optical pump, the beam property M² is over 150 for multi kilowatt laser pumped by lamps. Using diode laser as for side pumping, M² of lasers with rod active medium is also above 70. One of the ways to deal with this difficulty is to use an active mirror (W. Koechner, Solid State Laser Engineering, Springer, 1999, U.S. Pat. No. 3,631,362 (1971)), in which the laser medium is made into a thin disk. One side of the disk is used for pump beam illumination. The other side is a mirror and also used for cooling. Method is also developed by pressing a sapphire disk on the disk to avoid thermal deformation and help heat dissipation (Opt. Lett. V24, 1343 (1999). In the case of thin disk, the direction of the

### SUMMARY OF THE INVENTION

1. A device comprising:

At least one active mirror made of thin disk active medium having a pump surface and a mirror surface, wherein the pump surface of said active mirror accepts pump beam;

Means for cooling that contacts with the mirror surface of the active medium dissipating heat from said laser medium;

Pump beam, such as diode laser pump beam, illuminating the pump surface of said active mirror;

Multi-reflection optical system wherein the pump beam is imaged numerous times with the beam structure substantially unchanged during imaging leading to sufficient absorption of the pump beam by said thin disk active medium;

The device can further include a transparent medium as a cap having a good contact with the pump surface of said active mirror to improve heat dissipation and correct deformation.

The device can further include an external cavity structure to form a laser oscillator with said active medium. Furthermore, said multi-reflection optical system can be used with active mirror to form a laser amplifier so that the energy in laser medium can be extracted sufficiently.

Said multi-reflection optical system can comprise a large spherical mirror and two small spherical mirrors with at least one small spherical mirror being the mirror surface of active mirror.

Said multi-reflection optical system can also comprise a roof prism (or a corner cube) and a small mirror located at the focal point of the optical system, wherein said small mirror is also the mirror surface of said active mirror.

Said multi-reflection optical system can also comprise two mirrors located at the focal point of two optical systems, respectively, wherein at least one of the small mirror is also the mirror surface of said active mirror.

Spherical active mirror with a cap can be helpful in suppress amplified spontaneous emission (ASE).

2. A device comprising:

At least one active mirror made of thin disk active medium having a pump surface and a mirror surface, wherein the pump surface of said active mirror accepts pump beam;

Means for cooling dissipating heat from said active mirror;

At least one optical pump source for emitting pump beam, such as diode laser pump beam, illuminating the pump surface of said active mirror;

A multi-reflection optical system comprising said active mirror and optical components wherein said active mirror and said optics components are arranged such that said pump beam is imaged numerous time in said multi-reflection system leading to sufficient absorption of the pump beam by said thin disk active medium;

Wherein said multi-reflection optical system can include several sets of mirrors having predetermined radii which are arranged in such a way with said active mirror that multi-imaging can be achieved by multi-reflection so that the pump beam can be sufficiently absorbed.

Wherein planar mirrors and lenses can be used to facilitate the multi-reflection process.

Wherein aspheric optics can be used to minimize aberration when necessary.

Wherein a hole can be included if necessary for solid-state laser output.

Wherein multiple pump sources are included.

Wherein the number of reflection imaging can be more than 10, more than 50, or more than a few hundred so that the pump beam can be absorbed sufficiently.

The device can further include a transparent medium as a cap having a good contact with the pump surface of said active mirror to improve heat dissipation and correct deformation.

The device can further include an external cavity structure to form a laser oscillator with said active medium. Furthermore, said multi-reflection optical system can be used with active mirror to form a laser amplifier so that the energy in laser medium can be extracted sufficiently.

Said multi-reflection optical system can comprise a large spherical mirror and two small spherical mirrors with at least one small spherical mirror being the mirror surface of active mirror.

Said multi-reflection optical system can also comprise a roof prism (or a corner cube) and a small mirror located at the focal point of the optical system, wherein said small mirror is also the mirror surface of said active mirror.

Said multi-reflection optical system can also comprise two mirrors located at the focal point of two optical systems, respectively, wherein at least one of the small mirror is also the mirror surface of said active mirror.

### BRIEF DESCRIPTION OF THE DRAWINGS

FIG. 1 shows an embodiment where multiple reflection of a beam can be achieved by using three spherical mirrors.

FIG. 2 illustrates another embodiment where the incident beam is not in the meridianal plane.

FIG. 3 shows another embodiment where the pump beam can be reflected by mirrors A and B for 33 times.

FIG. 4 shows an embodiment of beam conversion means comprising two lenses and a prism that convert the exit beam into an incident beam feeding back into the multiple reflection optical system.

FIG. 5 shows yet another embodiment where the pump beam can be reflected by mirrors A and B for 44 times.

FIG. 6a illustrates an embodiment of a second type of multi-imaging optical system, including a roof prism RP. FIG. 6(b) shows the stepwise imaging in the PP plane. FIG. 6(c) is an embodiment where the prism in FIG. 6(a) is replaced with a planar mirror M. The result will be the structure shown in FIG. 6(c), where planar mirror M is positioned at the aperture stop plane and perpendicular to optical axis OO′. The structure in FIG. 6(d) is a variation of embodiment in FIG. 6(c) where there is a small angle θ between B and A.

FIG. 7(a) shows an embodiment using corner cube in the multi-reflection system. FIG. 7(b) illustrates the multiple reflection order as indicated by the beam positions.

FIG. 8 shows yet another embodiment where two small mirrors are located at the focal point of two optical systems, respectively. FIG. 8(b) shows a similar embodiment where the multi-reflection system has two off-axis parabolic mirrors to compensate coma aberration for each other.

FIG. 9 shows an embodiment where a structure of active mirror is used as laser oscillator, in which A and B are the active mirrors having a structure shown in FIG. 10.

FIG. 10 shows the structure or configuration of a typical active mirror.

FIG. 11(a) and FIG. 11 (b) illustrates embodiment when multi-reflection imaging system is used for laser amplifier.

### DETAILED DESCRIPTION OF THE INVENTION

The purpose of the present invention is to provide structures and methods that can be used to form high power solid-state laser systems with high beam quality.

It is the objective of this invention to provide a method for effective illumination of an active mirror comprising active medium (such as a thin crystal disk doped with rare earth materials). The effective illumination is achieved by multi-reflection and multi-imaging process. Comparing with prior art where only a few reflections can be made, the method disclosed here can lead to a predetermined large number of reflection and imaging in order to maximize the absorption of energy by the active medium (or laser medium). The number of imaging and reflection can be planned carefully based on need by properly designing the multi-imaging process.

It is another objective of this invention to provide a method for effective illumination of an active mirror comprising active medium by making the active mirror part of the multi-imaging process in a multi-imaging system comprising a plurality of well-designed mirrors or other reflective components. Lenses can be included in the system. The well-designed mirrors could include spherical mirrors, planar mirrors, or even aspheric mirrors. The system can further include lenses, prisms or other components to alter the beam path and control the number of reflections and the multi-imaging process. In the prior art, only limited number of reflection can be made at the active mirror. This limits the absorption of pump beam and also limits the effectiveness of cooling. With the method disclosed in this invention, by multi-imaging resulted from multi-reflection of beam in, for example, a mirror system comprising three spherical mirrors (including at least one active mirror), tens or even over one hundred times of reflections at the active mirror can be realized leading to high efficiency of absorption as well as better cooling because the active mirror can be made very thin.

It is another objective of this invention to use the multi-imaging illumination system to construct a laser oscillator or laser amplifier by further including a cavity mirror. Besides the active mirror, it is possible to use one of the mirrors for multi-imaging and multi-reflection as the other cavity mirror for laser output. Holes on mirrors can also be included to facilitate the laser output. A hole can always be added to a mirror at the location where pumping beam will not reach. Such location can be easily found by tracing the path of pump beam reflections.

Multi-Reflection Optical System

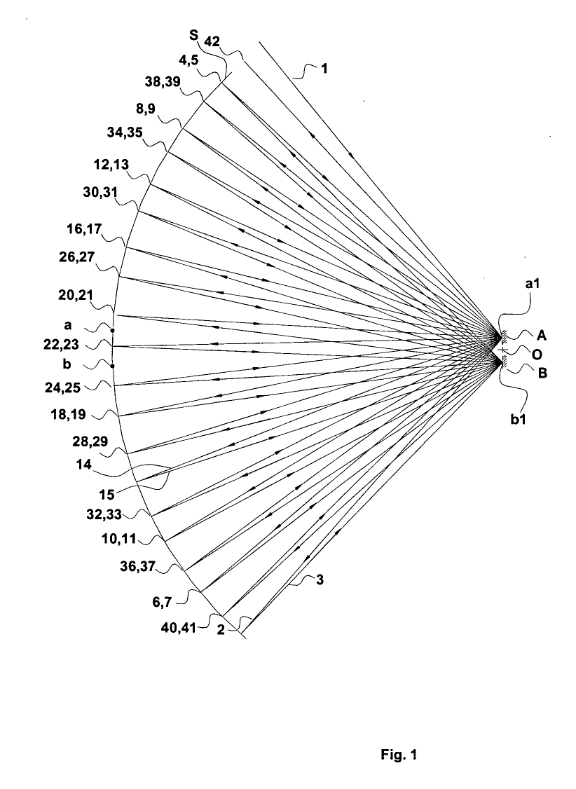

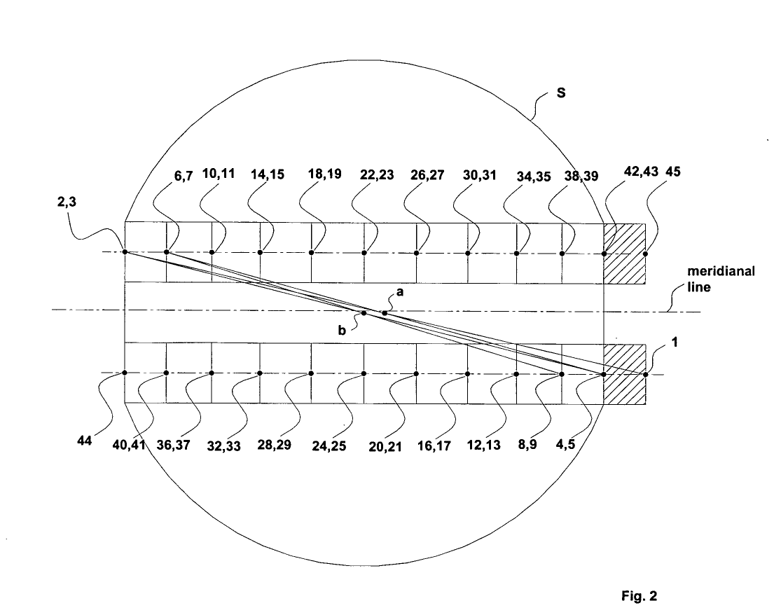

FIG. 1 shows an optical system in which multiple reflection of a beam can be achieved by using spherical mirrors. The spherical center of the large spherical mirror S is located at point O. Two small spherical mirrors A and B are placed near point O, where the spherical centers a and b are placed at S. The radii of three spherical mirrors are similar.

The distance between spherical centers a and b is d. When beam 1 strikes mirror A at point a1, reflection beam 2 is formed which is symmetrical to beam 1 with respect to the normal through a. Beam 2 is further reflected by mirror S into beam 3, which is symmetrical to beam 2 with respect to the normal through O. Beam 3 then strikes mirror B at point b1 and is reflected to be beam 4. Beams 3 and 4 are symmetrical with respect to the normal through b. Beam 4 is then reflected by mirror S into beam 5, which is reflected back to a point close to a1 on mirror A. At this point, one reflection cycle is completed. After this cycle of multi-reflection, beam 5 and beam 1 do not overlap with each other. Instead, there is an angle between these two beams. Half of this angle is substantially equal to the angle aOb, but because of the aberration of spherical mirror at large field of view, the difference may be appreciable, and it can also be affected by the arrangement or location of mirror A and B. Correspondingly, the distance of beam 1 and 5 at mirror S is about 2d. The next reflection cycle begins when beam 5 is further reflected by mirror A into beam 6. At the end of each reflection cycle, the position of the beam on mirror S will shift by 2d if not considering aberration. The beam thus always shifts from the edge of mirror S to its center and to the other edge, and eventually shifts out of the edge. Therefore the ratio of mirror dimension and d determines the number of reflection. With the dimension shown in FIG. 1, after beam 22 strikes mirror S between point a and b, beams starts to shift toward the edge. In this figure beam 42 will go out of the edge of mirror S.

In FIG. 1, if consider the spherical surface of mirror S as an arc, the vertex angle at center O is about 90°. The angle between beam 1 and beam 5 is about 10° (The central angle for arc ab is about 5°). The spherical surface can thus be divided into 9 portions, and the beam can strike mirror A and mirror B for 10-11 times, respectively. The smaller the angle between beams, the more the number of possible reflection.

Point a1 and point b1 are the object and image points of spherical mirror S near its spherical center. The multiple imaging resulted from multiple reflections could enlarge the point size due to aberration, but the aberration near the spherical center is very small.

By considering the plane containing three spherical centers a, b and o as the meridianal plane, in the example shown in FIG. 1, incident beam is also in this plane. When the incident beam is not in this plane, but still strike at point a1 of spherical mirror A, the reflection beam 2 will still symmetrical with beam 1 with respect to the normal through point a, as shown in FIG. 2. In FIG. 2, the spherical surface is unfolded into a plane, and only the positions where each beam strikes mirror S are shown. In this figure, meridianal line is the cross line of the meridianal plane and the spherical surface of the mirror, passing through points a and b. Each cross point of beams with S is indicated along with the projection of beam 1 to beam 8 on spherical mirror S. All cross points of beams with mirror S are located on two lines, respectively. These two lines are symmetrical with respect to the meridianal line. The distance between each two neighboring points is about twice as long as d (˜2d), which is the same as the regularity of reflections within the meridianal plane. Similar as in FIG. 1, the beams gradually shift to the center of mirror S and then to the edge. In FIG. 2, an edge of mirror S is trimmed for beam input and output. The shadowed squares indicate the incident and exit positions of beams having a certain solid angle. Similar to FIG. 1, FIG. 2 shows the situation where mirror S has a vertex angle of about 100° and the solid angle of the incident beam is about 10°×10°. Each of the squares shows the occupied areas of beams on the spherical mirror S during the multi-reflection process.

At shadowed area for the exit beam, a small spherical mirror can be placed with its spherical center located at a1 of mirror A, and the exit beam will be reflected back along the original path all the way back to the entrance position. Therefore, when the incident beam is not in the meridianal plane, the number of reflection can be easily doubled. In the structure shown in FIG. 2, the pump beam can be reflected by mirrors A and B for 22 times, respectively.

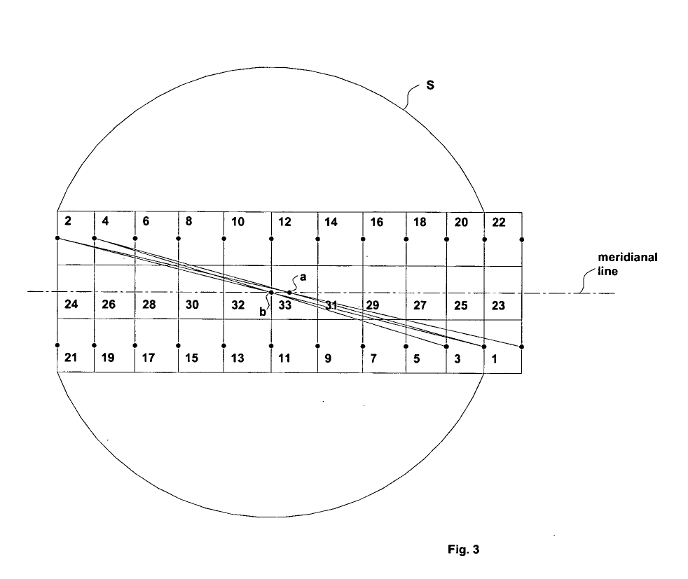

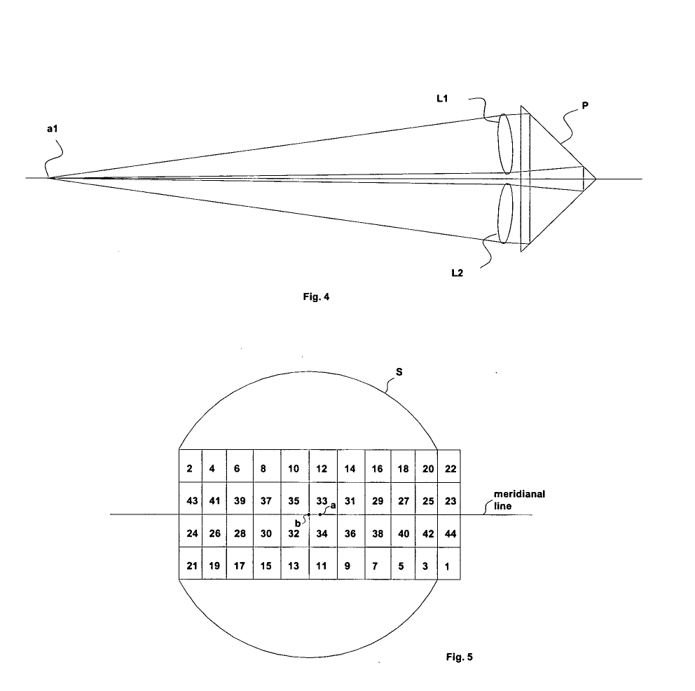

FIG. 3 shows a scheme where the pump beam can be reflected by mirrors A and B for 33 times. As in FIG. 2, only the positions where each beam strikes mirror S during the reflections are shown. One edge of mirror S is trimmed for incident beam from position 1 to point a1 on mirror A. After multiple reflection, the beam exit from position 22. A beam conversion means can be used to make the exit beam into a beam incident from position 23 onto point a1 of mirror A, forming an incident beam within the median plane. Based on the regularity described above, the beam will strike on position 33 to point a1 of mirror A. Since the center of position 33 is the spherical center of mirror A, the beam will be reflected back along the original path to position 1.

FIG. 4 shows one beam conversion means out of many possibilities. This beam conversion means comprises lens group having two lenses L1 and L2, and a prism P. Lens L1 collimates the beam from a1, and lens L2 focuses the collimated beam back to a1. The function of prism P is to translate the beam from one location to another to complete desired beam conversion.

FIG. 5 shows a scheme where the pump beam can be reflected by mirrors A and B for 44 times. In order to increase the number of reflection of a beam with a solid angle of about 10°×10°, the vertex angle of spherical mirror S to its spherical center can be increased to 110°. One edge is trimmed for incident and exit beam. Similar to scheme shown in FIG. 3, a beam conversion means is placed in the path between positions 22 and 23 so that after a beam strikes point a1 from position 1, it can be reflected to position 44 after multiple reflections between mirror S and mirrors A and B. A small spherical mirror is placed at position 44 with its spherical center located at a1 to reflect the beam back along its original path to position 1.

It is apparent that using the same method, the number of reflection can be further increased by a factor of 5 or more until the beam fills the total area of mirror S. In other words, the number of reflection can be increased until the whole solid angle of mirror S is filled.

It is apparent that the method described by the present invention shows a way to form a multi-reflection optical system. The number of reflection within this system is determined by the ratio of the solid vertex angle of mirror S to its spherical center and the solid angle of the beam. Since the solid vertex angle of mirror S is smaller than 2π, the maximum number of reflection is determined by the solid angle of the beam. The dimension of the solid angle of incident beam could also determine the power level of the incident optical pump beam.

In the examples described above, the solid angle of the incident beam is set at about 10°×10°, that is NA 0.09×0.09. In this case, it is rather easy to achieve 44 reflections on mirror A and mirror B, respectively. The number of reflection will decrease with (NA)².

In the situation where diode laser is used for illumination, high power beam is often obtained by grouping a number of laser diode arrays. Sometimes, it could be more convenient to use a few beams with lower power level to replace a single kilowatt pump beam source, as long as the beam brightness is high enough and the solid angle occupied by the illumination beam is the same size. If the scheme in FIG. 2 is selected, it is simpler to use it without considering the beam conversion means. By decreasing NA of the beam, it is easy to achieve over 22 reflections. Increasing the rows of beam spot on mirror S is one of the ways to increase the power level. The scheme in FIG. 2 has two rows. The one in FIG. 5 has four rows. A structure for doubling input power can be formed by using position 1 and position 23 of the scheme in FIG. 5 for incident beam, and using position 22 and 44 for small spherical mirrors that reflect the beams striking on them back along the original path. Mirror S can also be made into a square shape (such as one with a solid angle to its spherical center being 100°×100°) to accommodate multi-row input.

The aperture of beam incident into the multi-reflection optical system can have many possibilities such as circular, oval, square, or rectangular shapes. To fully use the whole spatial solid angle, it is preferred to have the aperture of the illumination beam being square or rectangle so that it is more efficient to fill the whole solid angle, and the same number of reflection will result in more power input.

In FIG. 1, the function of large mirror S is to form the image of a1 to b1, or from b1 to a1, with the magnification close to 1. Since the points are close to the spherical center, the spherical surface can forms image that is close to ideal. The function of small mirrors A and B is to form the image of one point on mirror S at another point on mirror S, with the magnification also being 1. When the dimension of mirror A and B are rather small, as long as the normal of mirror A passes through point a, and that of mirror B through b, all the discussions shown above are valid, no matter what is the radius of mirror A and mirror B. When the dimension of the beam striking on mirror A and B is increased to certain extent, the radius of mirror could cause the diffusion of beam spot on mirror S. For example, when mirror A is a plane mirror, the cross point of its normal with mirror S will have a certain size. Therefore when the beam spot on mirrors A and B is very small, the selection of radius can be arbitrary. Even plane mirror can be used.

In the disclosure described above, point a1 and b1 can be any pair of conjugate points close to point O. Therefore, a1 is both object point and image point with respect to b1, and vice versa. Object point a1 is imaged into b1 with magnification of 1, and vice versa.

During the multi-reflection process, multi-imaging occurs. Beam incident on object point a1 will also be the incident beam on mirror S, as discussed above. The beam spot on mirror S experiences 1:1 multi-imaging process involving mirror A and B. Therefore, the multi-reflection imaging system shown in FIG. 1 performs multiple imagine process for the incident beam while keeping the dimension of the beam including cross-section area and solid angle. On the other hand, non-1:1 imaging is also possible.

The cross-section area and solid angle of a pump beam determines the level of pumping power. The cross-section area of a pump beam on mirror S determines the number of reflections, while the divergence angle determines the size of the area of the beam on mirrors A and B.

Second Type Multi-Imaging Optical System

A second type of multi-imaging optical system is show in 6(a), including an optical system L. Point O is the focal point of L, and the distance from the focal point to L is the focal length f, in which optical axis OO′ passes through the focal point. At the focal point, a small plane mirror A is placed, which is perpendicular to the optical axis. Surface PP is the position of front focal plane of L, with the distance from L being also f. This scheme also includes a roof prism RP, of which the roof edge is located on surface PP, which is the stop plane of the optical system. The roof edge does not pass the optical axis, with a distance from the optical axis being d1.

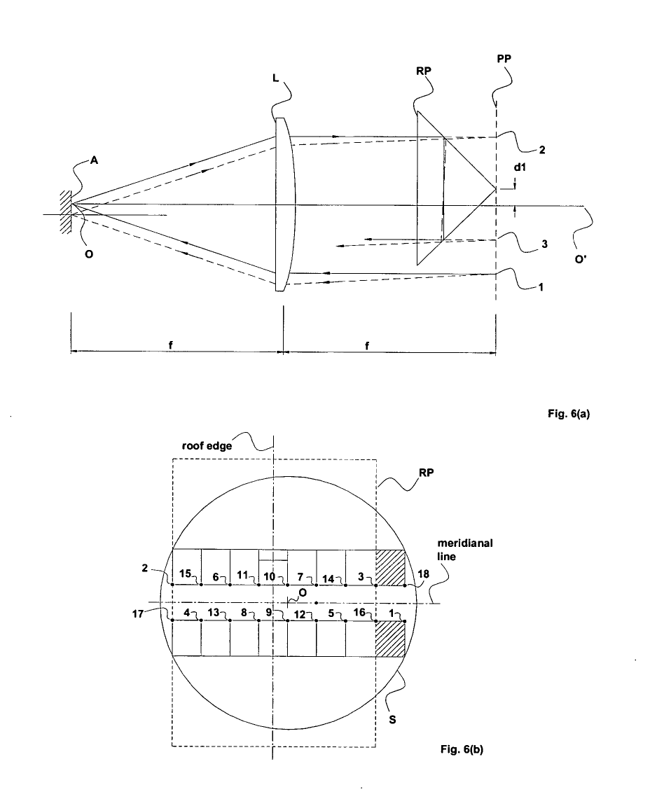

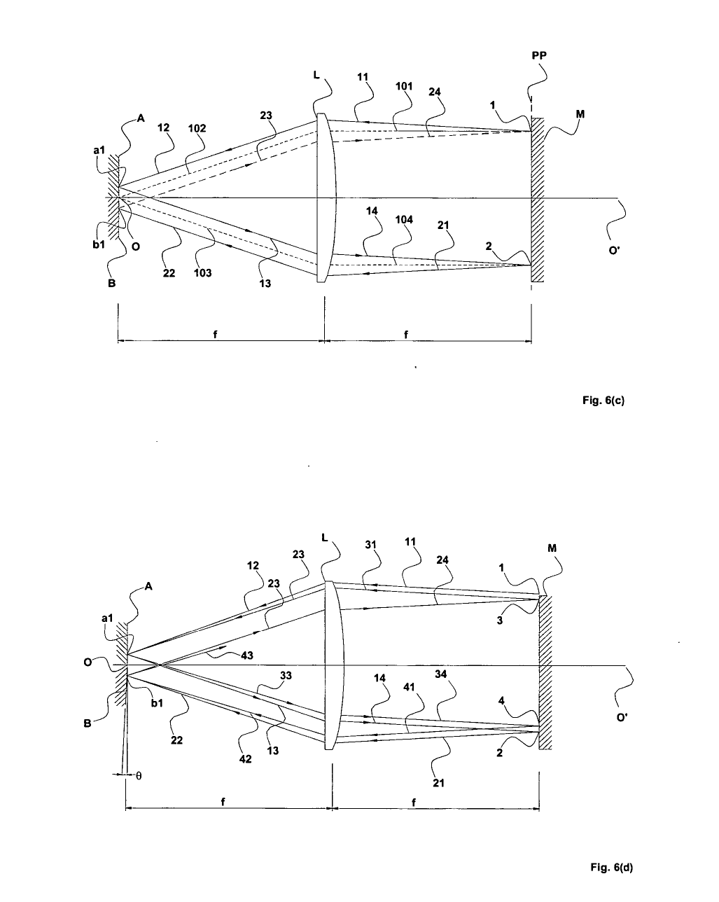

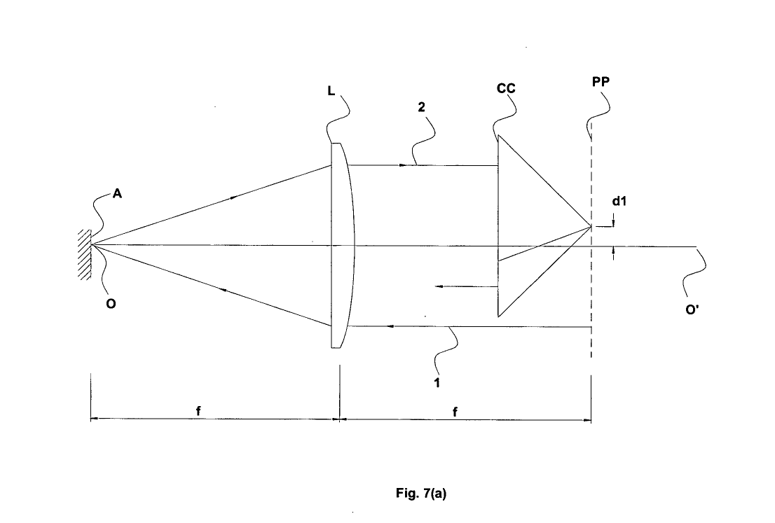

A beam parallel to the optical axis, emitted from point 1 of plane PP, is focused at point O by optical system L. It is then reflected by mirror A, with the reflection angle being the same as the incident angle, namely symmetrical with respect to the optical axis. The exit beam is refracted into beam 2, which is parallel to optical axis and intersects with plane PP at point 2. Points 1 and 2 are also symmetrical with respect to the optical axis. Beam 2 is then reflected twice by RP into beam 3, which is still parallel to the optical axis and intersects with plane PP at point 3. Beam from Point 3, which is symmetrical to point 2 with respect to the roof edge of RP, enters the optical system L again. After a cycle, point 3 will shift by approximately 2d1 relative to point 1. All beams from point 1 will experience the same cycling process. The dot line in FIG. 6(a) illustrates the beam from point 1 towards L. This beam is collimated by L into a collimated beam, which is reflected and then refocused at point 2, which is reflected by roof prism RP into a virtual image as image point 3.

Thus, the optical system, small mirrors, and the roof prism form a reflection system with multiple cycles. This is also an optical system of multi-imaging by reflection. The image points 2, 3 . . . of point 1 are all located in plane PP, and following the number of cycles the image point shifts in an order. Point O is also imaged during the multi-reflection imaging process, with its images always been overlapped at the same place.

FIG. 6(b) illustrates the case of the stepwise imaging in the PP plane, in which point O is the cross point of the optical axis and PP. The roof edge of the prism is shown. The distance of point O to the roof edge is d1. As mentioned earlier, the image point 2 and point 1 are symmetrical with respect to point O, the image point 3 of point 2 are symmetrical respect to the roof edge, the image point 4 and point 3 are symmetrical to point O, and the image point 5 of point 4 are also symmetrical to the roof edge, and so on. According to the dimension in 6(b), the beam from point 1 will be reflected on mirror A for 18 times and exit from point 18. The large circle in FIG. 6(b) is the clear aperture of the stop. The dot line is the prism edge. The shadowed area with dimension 2d1 having point 1 at one corner is the aperture of the incident beam, which passes multiple times through the region near point O of mirror A, occupy stepwise the numbered apertures in PP plane, and finally exit from the shadowed area with point 18 at its one corner. If a small plane mirror is placed at this position and reflect the beam back from its original path, the beam will return from point 18 to point 1 and thus reflect from mirror A for 36 times. It can be seen that this result is very similar to the example shown in FIG. 2. But due to the difference of symmetry, the order of stepwise shifting is very different.

Since this type of multi-imaging optical system is similar as the one discussed before, the method of multiplying the number of reflections and the method of using multiple input beam sources does not need to be repeated. Because the multiple reflections are within beam paths that are parallel to each other, the beam-transforming device can comprise easily plane mirror or prism. In summary, to obtain the maximum number of reflection, it is desired to make the beams of multiple reflections fill the aperture of PP as much as possible. The dimension ratio of the stop aperture and the incident beam aperture determines the number of reflection. By focusing with lens group L, this ratio is the maximum solid angle of the illumination optical system and the solid angle of the incident beam, just the same as mentioned before.

To obtain as many number of reflections as possible, the maximum aperture angle is 120°×120°, corresponding to NA 0.87. To achieve such large NA, complicated structure must be applied to lens group L. Aspheric, HOE (holographic optical elements), and DOE (diffractive optical elements) can also be used. Parabolic reflectors can also be used to replace L, but the possible center obscuration must be considered.

The right angle prism mentioned above can also be replaced with two planar mirrors positioned perpendicular to each other.

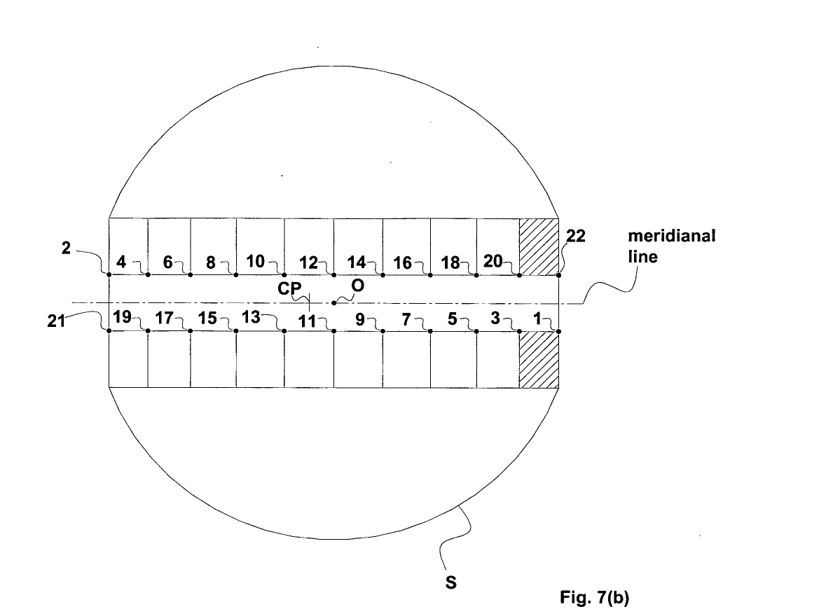

In the structure for multi-reflection in parallel beam paths shown in FIG. 6(a) and 6(b) the roof prism can be replaced with a corner cube as illustrated in FIG. 7(a). The incident beam and exit beam in a corner cube are parallel to each other and symmetrical with respect to the prism tip. Therefore, in this multi-reflection optical system comprising a corner cube and lens system L the multiple reflections will have an order as shown in FIG. 7(b) as indicated by the beam positions, where 0 is the cross point of the optical axis and PP, CP is the prism tip with the distance from optical axis being d1. The line linking O and CP is the meridianal line.

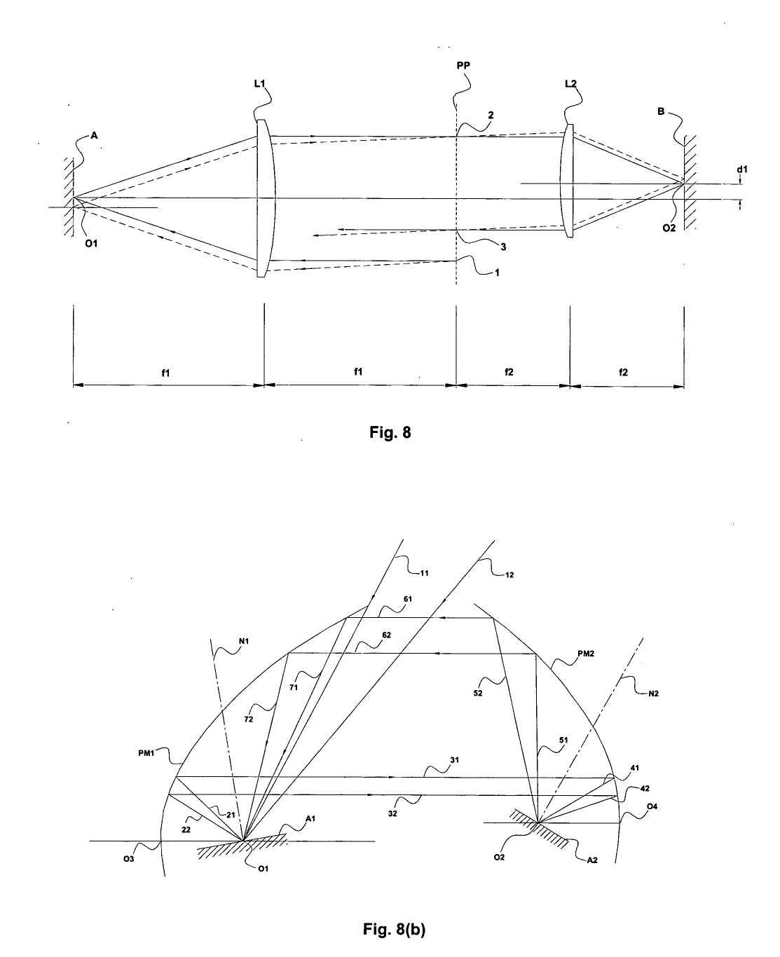

To achieve multiple reflection in paths that are parallel to each other, the optical system can also comprise two small mirrors located at the focal point of two optical systems, respectively, as shown in FIG. 8. This optical scheme shows two optical systems. The optical system L1 has a focal length f1, and the optical system L2 has a focal length f2. Two mirrors A and B are placed at the two focal points, respectively, with the mirrors perpendicular to the optical axis. The two optical systems are parallel to each other, and the optical axes do not overlap. The distance between the two optical axes is d1. The plane of the stop PP is also located in the focal plane of these two optical systems. The incident beam (solid line) parallel to the optical axis from point 1 is focused by optical system L1 at O1, which is on the optical axis. After being reflected by mirror A, the beam is collimated by L1 to form a beam that is parallel to the optical axis and crosses PP at point 2. Point 2 and point 1 are symmetrical with respect to optical axis at O1. This beam parallel to the optical axis is then enters L2 and is focused at point O2 located on the optical axis, reflected by mirror B, collimated by L2, and crosses plane PP at point 3. Point 3 and point 2 are symmetrical to the optical axis at O2. In this scheme, the stepwise imaging of the beam from point 1 (dot line) is also shown, indicating that point 2 is the image of point 1 and point 3 is the image of point 2.

Therefore, in the optical system shown in FIG. 8, the characteristics of multi-imaging is the same as the one shown in FIG. 7(b) when O in point 7(b) is replaced with O1, and CP is replaced with O2.

The refraction optical system shown in FIGS. 6, 7, and 8 can also be replaced with reflection optical system. However when coaxial catadioptric optical system is used, obscuration could occur at the center. Therefore, off-axis optical system is preferred in this case. The simplest example is to use off-axis parabolic mirrors. Although axial collimated beam could be precisely focused at a point with such mirrors, coma aberration could be significant. Different portions of the beam could show quite different magnification (focal length) so that the beam spot dimension increases rapidly during multiple imaging. Nevertheless, methods can be used to compensate the aberration. One example is to use a multi-reflection system having two off-axis parabolic mirrors to compensate coma aberration for each other as shown in FIG. 8(b).

In FIG. 8(b), the vertexes of parabolic mirrors PM1 and PM2 are O3 and O4, respectively. The focal points are O1 and O2. The axis O3O1 and O2O4 are parallel to each other without overlapping. At the focal points, plane mirrors A1 and A2 are placed, with the normal of the mirrors O1N1 and O2N2 being properly tilted so that the illumination beam 11-12 can form a cyclic path. Beams 11-12 entering at the focal point O1 of PM1 are reflected by mirror A1 into beams 21-22, which are reflected by PM1 into beams 31-32 parallel to the axis, focused by PM2 at O2 as beams 41-42. The beams are further reflected by mirror A2 into 51-52, which are reflected by PM2 into beam 61-62 parallel to the axis, and then focused at O2 by PM as beam 71-72, completing a cycle. It can be noted that the angle between beams 41-42 is the same as that between 51-52, but the widths between corresponding collimated beams 31-32 and between beams 61-62 are very different. Namely the focal lengths of these two mirror regions are quite different. In general, the angle between beams 11-12 and that between 71-72 will not be the same (The coma aberrations of these two off-axis parabolic mirrors can not be completely cancelled because the axes do not overlap). Therefore the focal spot dimension of a beam on A1 and A2 will change along with the cycling process. On the other hand, because the back focal plane of the off-axis parabolic mirror is far from being planar (the focal length at area 61-62 is more than double comparing with the focal length in region 31-32), an incident parallel beam at A1 will no long a parallel beam after a cycle of reflection, and the beam shape could not be kept unchanged during the cycling reflection process.

On the other hand, the prism in FIG. 6(a) can also be replaced with a planar mirror M. The result will be the structure shown in FIG. 6(c), where planar mirror M is positioned at the aperture stop plane and perpendicular to optical axis OO′. The beam 101 emitted from point 1 that is parallel to the optical axis is focused by lens L at a1 and becomes beam 102 that intersects mirror A, B at point O on the optical axis. The reflection beams 103 and 102 are symmetrical with respect to the optical axis. Beam 103 is then collimated by L into 104, which is parallel to the optical axis and intersects M at point 2. Points 2 and 1 are symmetrical with respect to the optical axis also. The beam 11 from point 1 is refracted by L into beam 12. Since point 1 is located at front focal plane, beam 12 and 102 are parallel to each other, after reflection beams 13 and 103 are parallel to each other, and after refraction beams 14 and 104 are both focused at point 2. Beams 14 and 11 are parallel to each other (assuming a1 as the source; a1 is at a focal plane). Beam 14 is reflected by M into beams 21, 22, 23, 24. Beam 24 is then reflected by M into beam 11. This is an optical path of continuous cycle.

The structure in FIG. 6(d) is different from FIG. 6(c) in that the small mirror A is perpendicular to the OO′ and there is a small angle θ between B and A. With this structure, beam 11 emitted from point 1 after position 22, unlike in FIG. 6(c), the reflection beam 23 is not parallel to 12, with a small angle 2θ. Beams 24 and 21 are still parallel to each other (both using b1 as the source). Beam 24 intersects M at point 3. The distance between point 1 and 3 is 2fθ. Beam 24 is then reflected by M in to beam 31, which is parallel to beam 11 and is focused by L at a1. The beams by refraction and reflection are in the following order: 21, 22, 24, 41, 42, and 43. From 11 to 31, one cycle is completed. The result of each cycle is a shift of 2fθ, and the beam from point 1 gradually shifts downward in FIG. 6(d) until out of the optical stop. Beam 2 is the image of point 1, point 3 is the image of point 2, point 4 is the image of point 3, and so on. The image points gradually shift upward in FIG. 6(d) by 2fθ in each step as shown by the even number image points (2, 4 . . . ) until out of the optical stop. As in other examples, a1 is the image of b1 and vice versa.

In FIG. 6(c) and FIG. 6(d), when the distance of mirror M and lens L is not equal to the focal length f, it is still possible to keep the 1:1 object/image relationship between point 2 and point 1. In this case, mirror A and B will not be planar mirrors, but spherical mirrors. On the other hand, mirror M can also be a spherical mirror, which can keep the 1:1 object/image relationship between a1 and b1. In this case, the distance from mirrors A and B from L will be changed, no longer equal to focal length f. The method described in this paragraph also can be applied to other examples described in this disclosure.

Active Mirror as Laser Oscillator

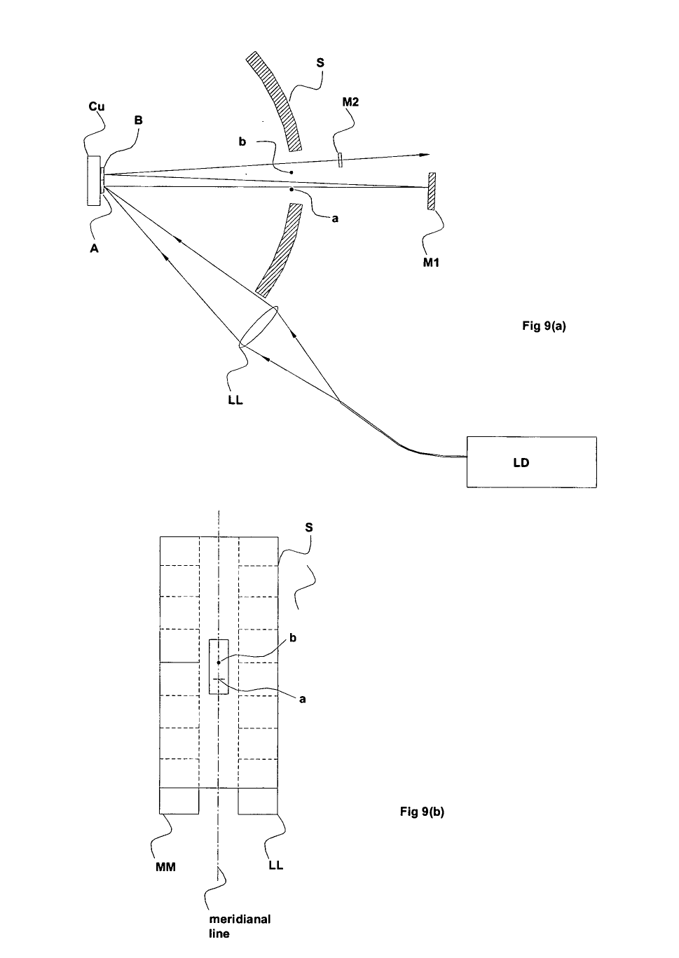

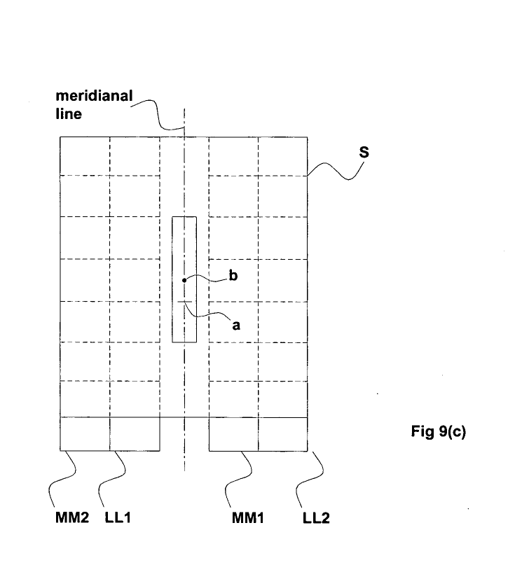

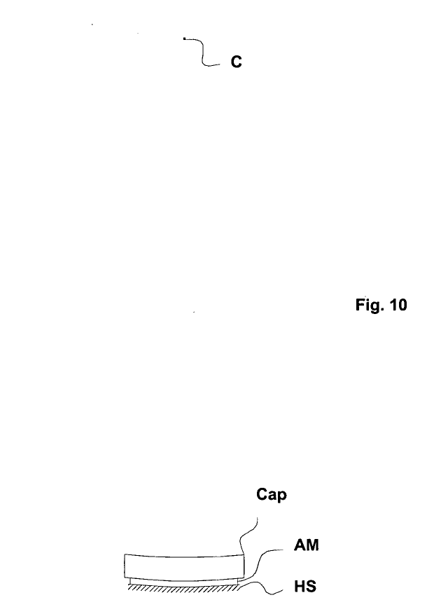

A structure of active mirror as laser oscillator is shown in FIG. 9, in which A and B are the active mirrors having a structure shown in FIG. 10. A and B are cooled with a cooling system Cu. S is a spherical reflector, which forms a multi-reflection imaging system with A and B. In this scheme, the beam source LD is delivered with a fiber. The optical system LL forms the image of the fiber end on mirror A. This beam is then multiply imaged by the multi-reflection optical system comprising S, A and B, illuminating active mirrors A and B. LL usually is not in the meridianal plane containing the spherical centers of S, A and B, as illustrated in FIG. 9(b). Mirrors M1, M2, A and B forms a cavity of resonator, in which A is the rear cavity, M1 reflects the beam from A on mirror B, and M2 is the front cavity for laser output. A hole can be made on mirror S near the meridianal plane so that the beam in the oscillation cavity can pass through as shown in FIG. 9(b). FIG. 9(b) is the unfolded form of mirror S, indicating the positions of the beams incident through LL, and the beam positions occupied by beams during the multi-imaging process (dot line). In this scheme, the radius of mirror MM is the same as S, but the positions of spherical centers are different where mirror MM acts a mirror for doubling the number of imaging reflection. FIG. 9(b) shows the example where the beam reflects for 15 times from mirrors A and B, respectively.

FIG. 10 illustrates the structure of one type of active mirror AM. In general, AM can be a thin disk formed with a crystal or ceramic, such as Yb:YAG, Nd:YAG, Nd:YVO4 or other materials doped with active species. The front and back surfaces of the disc are both spherical, with the back surface coated with a high reflection coating. The disc can also have aspheric surfaces. The cap is made of a transparent material with high heat conductivity, which can be selected from sapphire, YAG, or diamond. It is preferred that the cap contacts with a heat sink for heat removal. One possibility is to make the dimension of cap larger than AM so the cap can have contact with a heat sink. For a spherical disc cap, the front and back surface can also be spherical with the back surface curvature being the same as the front surface of AM so that the two surface can have a good contact or can have optical contact or can be bonded together such as by sintering. The front surface of the cap can be coated with an anti-reflection coating. In FIG. 10, all the spherical surfaces of AM and the cap have a common spherical center C, that is the surfaces are concentric. In this case, the imaging characteristics of the disk/cap unit are the same as that of a single spherical mirror having a spherical center C. Nevertheless, concentricity is not a necessary condition.

Since the diameter of active mirror is much larger than the thickness, ASE (amplified spontaneous-emission) becomes the main source of laser loss. Proper structure can reduce this loss. For example, due to the use of curved surface along with a cap, instead of a plane surface, ASE can be greatly decreased.

With similar structure, the active mirror can also be made of a flat thin disk or thin film doped with active species.

At the present time, laser diode pump sources are easily available with over 500 W power delivered from a 0.6 mm fiber, NA 0.22 such as F500-xxx-6 made by Apollo Instruments, Inc. Using an optical system LL to form the 4×image of the fiber end, the spot dimension on the active mirrors A and B will be 2.4 mm, respectively, with a numerical aperture of illumination less than 0.06. Thus, in order to make the beam in and out of the active mirrors A and B for 30 times, respectively, the illumination beam will occupy 54° with the mirror extend angle of 48°. The thickness of AM can be smaller than 0.2 mm and the working temperature can be controlled at about 25°.

With beam shaping, over 4 kW power can be delivered from a 1.5 mm fiber. With such pump source, laser modules of 2 kW can be made. Using an optical system LL to perform 4×imaging of the fiber end, the beam diameter on mirror A and B will be 6 mm, respectively, with NA<0.06. To make the illumination beam in and out each of the active mirrors for 30 times, respectively, the required angle for the illumination beam will also just be 54°.

As another example, a pump source delivering 2 kW from a 1.5 mm fiber, NA 0.22, can also be used. By using two 2 kW sources, two individual optical systems LL1 and LL2 can be used to form the 4×images of the two fiber ends on mirror A, respectively. The location of LL1 and LL2 are shown in FIG. 9(c). The radius of mirror MM1 and MM2 are the same as that of mirror S so that the number of imaging reflection can be doubled. In this case, the spot dimension on mirror A will still be 6 mm, with each of two illumination beams occupying NA 0.06, doubling the spatial solid angle of the whole illumination beam. By increasing the dimension of mirror S in one direction, a laser module with 4 kW input and 2 kW output can still be formed if the laser optical efficiency is 50%.

Collimated beam, without being coupled into an optical fiber, can also be used for direct illumination of the active mirror. From the above examples, it can be seen that the increase in solid angle (NA) of illumination beam, more power can be input into the system. Since the 4 kW input mentioned above only requires an solid angle that is not too large, it is possible to input>10 kW to form laser modules with over 5 kW output.

It should be noted that when the brightness of the illumination beam decreases, the required spatial solid angle would increase. On the other hand, increasing the spot dimension on the active mirror, the power density of the pump beam will decrease, followed by the decrease in the spatial solid angle occupied by the pump beam.

Multiple modules mentioned above can be put in series to form a laser of much higher output power.

Active Mirror as Laser Amplifier

If the active mirror is used for a laser amplifier, the amplified laser beam must travel multiple times to extract energy from the thin disc. Not only can the multi-reflection imaging system be used for laser pump illumination, it can also be used as laser amplifiers. Pump and amplifier can use the same or different multi-reflection optical system. They can also use a different region of a commonly shared optical system.

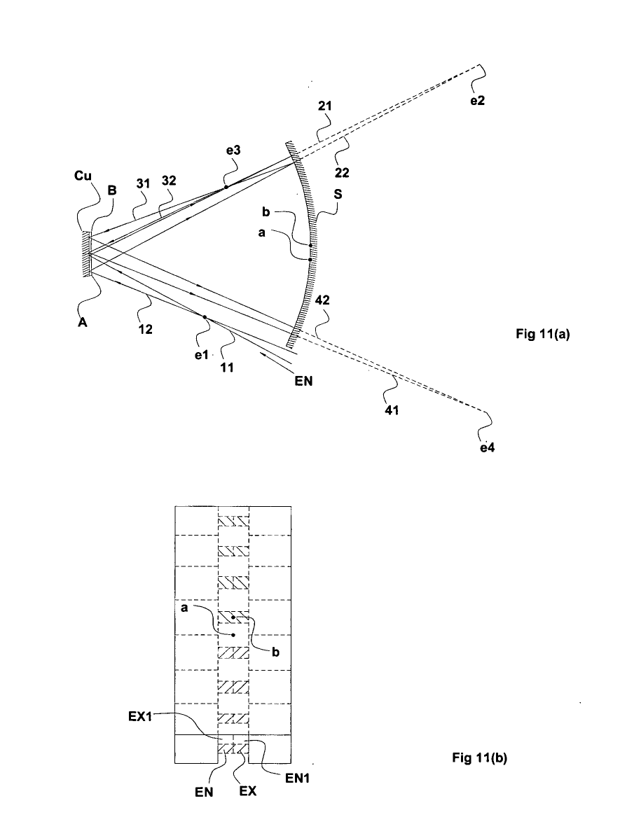

Unlike the pump beam, the amplified laser beam has a very small divergence angle. For example, the beam can be a collimated beam with very small divergence angle. In order to extract the energy stored in the active mirrors, the beam spot dimension of this low divergence beam on mirror A and B should be similar with that of the pump beam. The dimension on mirror S should also not be made too small. FIG. 11(a) shows the amplified laser beam 11 and 12 are focused at point e1, which is reflected into beams 21 and 22 by mirror A having its spherical center at point a, and then focused at pint e2. The beam is then reflected by mirror S into beam 31, 32 and focused at point e3. The beam is then further reflected into beams 41, 42 by mirror B having its spherical center at point b, and focused at point e4, and so on. The focal point position e1 of the incident beam is arbitrary. When e1 is located in the middle between A and S, namely at the focal plane of A, e2, e4, etc will be at infinity, and the beam spot dimension on mirrors A, B and S will be the same. The situation is the same if the incident beam is a collimated beam. FIG. 11(b) is the case where e1 is more close to S, where the beam spot dimension on S does not change, but smaller than the spot dimension on mirror A. When e1 is very close to S, the spot size on mirror S could be too small, which could cause laser damage sometimes.

FIG. 11(b) illustrates the areas occupied by each beam on mirror S. In this case, the amplified beam and the pump beam use different spatial regions of the same multi-reflection imaging system. The area used by the pump beam is the same as in FIG. 9. The amplified laser beam strikes mirror A from position EN, and finally exit from position, EX, occupying the shadowed regions. The reflection number on mirrors A and B is 16 times and 14 times, respectively. If it is desired to make the laser beam experience more reflections on the active mirrors, the beam can be transformed at position EX and become a beam incident from EN1. The reflection number can thus be doubled when the beam exit from position EX1.

Using multi-reflection imaging optical system, it is possible to reflect over hundred times on an active mirror in order to amplify a laser beam. Such amplifier can be used to replace regenerative amplifiers that have complicate structures.

Active Mirror as Q-Switch lasers

Besides forming amplifiers as mentioned above, a multi-reflection imaging optical path for realizing multiple reflection at an active mirror can also be used as an oscillator. For example, by placing cavity mirrors at position EN and EX for beam feedback, a laser oscillator using multiple reflection active mirror can be easily formed. Since the gain in the cavity can be high enough, switch can be inserted in the oscillator to form a novel active mirror Q-switch laser.

Changes and modifications in the specifically described embodiments can be implemented without departing from the scope of the invention, which is intended to be limited only by the scope of the appended claims.

1. A laser apparatus comprising:
At least one active mirror made of thin disk active medium having a pump surface and a mirror surface;
Means for cooling that contacts with the mirror surface of said active medium dissipating heat from said active mirror;
At least one optical pump source illuminating the pump surface of said active mirror;
Multi-reflection optical system wherein said pump beam is imaged numerous times onto the pump surface of said active mirror leading to sufficient absorption of said pump beam by said thin disk active medium;
Wherein said active mirror is part of said multi-reflection optical system, and the number of reflection from said active mirror is significant larger than the number of reflection components in said multi-reflection optical system.

2. A laser apparatus as in claim 1, where the ratio of the number of reflection from said active mirror to the number of reflection components in said multi-reflection optical system is larger than 3.

3. A laser apparatus as in claim 1, where the ratio of the number of reflection from said active mirror to the number of reflection components in said multi-reflection optical system is larger than 10.

4. A laser apparatus as in claim 1, further including a transparent medium as a cap having a good contact with the pump surface of said active mirror to improve heat dissipation and correct deformation.

5. A laser apparatus as in claim 1, further including an external cavity structure to form a laser oscillator with said active mirror.

6. A laser apparatus as in claim 1, wherein said multi-reflection optical system is a part of a laser amplifier.

7. A laser apparatus as in claim 1, wherein said multi-reflection optical system comprises a large spherical mirror and two small spherical mirrors with at least one said small spherical mirror being the mirror surface of said active mirror.

8. A laser apparatus as in claim 1, wherein said multi-reflection optical system comprises a roof prism and a small mirror, with said small mirror being the mirror surface of said active mirror.

9. A laser apparatus as in claim 1, wherein said multi-reflection optical system comprises a corner cube and a small mirror, with said small mirror being the mirror surface of said active mirror.

10. A laser apparatus as in claim 1, wherein said multi-reflection optical system comprises two mirrors located at the focal point of the two optical systems, wherein at least one of said small mirror is the mirror surface of said active mirror.

11. A laser apparatus comprising:
At least one active mirror made of thin disk active medium having a pump surface and a mirror surface;
Means for cooling dissipating heat from said active mirror;
At least one optical pump source illuminating the pump surface of said active mirror;
Multi-reflection optical system comprising said active mirror and optical components wherein said active mirror and said optics components are arranged such that said pump beam is imaged numerous time in said multi-reflection system leading to sufficient absorption of the pump beam by said thin disk active medium;
Wherein said active mirror is part of said multi-reflection optical system, and the number of reflection from said active mirror is significant larger than the number of reflection components in said multi-reflection optical system.

12. A laser apparatus as in claim 11, where the ratio of the number of reflection from said active mirror to the number of reflection components in said multi-reflection optical system is larger than 3.

13. A laser apparatus as in claim 11, where the ratio of the number of reflection from said active mirror to the number of reflection components in said multi-reflection optical system is larger than 10.

14. A laser apparatus as in claim 11, wherein said multi-reflection optical system includes several sets of mirrors having predetermined radii.

15. A laser apparatus as in claim 11, wherein said multi-reflection optical system includes planar mirrors and lenses.

16. A laser apparatus as in claim 11, wherein said multi-reflection optical system includes aspheric optics.

17. A laser apparatus as in claim 11, wherein a hole can be included laser output.

18. A laser apparatus as in claim 11, further including a transparent medium as a cap having a good contact with the pump surface of said active mirror to improve heat dissipation and correct deformation.

19. A laser apparatus as in claim 11, further including an external cavity structure to form a laser oscillator with said active mirror.

20. A laser apparatus as in claim 11, wherein said multi-reflection optical system is a part of a laser amplifier.

21. A laser apparatus as in claim 11, wherein said multi-reflection optical system comprises a large spherical mirror and two small spherical mirrors with at least one said small spherical mirror being the mirror surface of said active mirror.

22. A laser apparatus as in claim 11, wherein said multi-reflection optical system comprises a roof prism and a small mirror, with said small mirror being the mirror surface of said active mirror.

23. A laser apparatus as in claim 11, wherein said multi-reflection optical system comprises a corner cube and a small mirror, with said small mirror being the mirror surface of said active mirror.

24. A laser apparatus as in claim 11, wherein said multi-reflection optical system comprises two mirrors located at the focal point of the two optical systems, wherein at least one of said small mirror is the mirror surface of said active mirror.
